(19) United States
(12) Patent Application Publication
(10) Pub. No.: US 2024/0323704 A1
(43) Pub. Date: Sep. 26, 2024

(54) IOT COMMUNICATION SYSTEM, ACCESS POINT, SENSOR DEVICE, IOT COMMUNICATION METHOD AND PROGRAM

(71) Applicant: NIPPON TELEGRAPH AND TELEPHONE CORPORATION, Tokyo (JP)

(72) Inventors: Ryota SHIINA, Musashino-shi, Tokyo (JP); Shinya TAMAKI, Musashino-shi, Tokyo (JP); Tetsuya SUZUKI, Musashino-shi, Tokyo (JP); Yasutaka KIMURA, Musashino-shi, Tokyo (JP); Tomohiro TANIGUCHI, Musashino-shi, Tokyo (JP); Sei KOU, Musashino-shi, Tokyo (JP); Tomoya HATANO, Musashino-shi, Tokyo (JP); Takashi YAMADA, Musashino-shi, Tokyo (JP)

(73) Assignee: NIPPON TELEGRAPH AND TELEPHONE CORPORATION, Tokyo (JP)

(21) Appl. No.: 18/269,370

(22) PCT Filed: Dec. 28, 2020
(86) PCT No.: PCT/JP2020/049062

§ 371 Date: Jun. 23, 2023

(51) Int. Cl. H04W 16/28; H04W 28/06; H04W 64/00

(52) U.S. Cl. CPC H04W 16/28; H04W 28/06; H04W 64/00

(57) ABSTRACT

An object of the present disclosure is to reduce traffic required for transmission of beacon information from a sensor apparatus to an access point and reduce power consumption without affecting position estimation processing in a high-order cloud or server.

In order to achieve the above object, an Internet of Things (IoT) communication system according to the present disclosure is the IoT communication system including one or a plurality of sensor apparatuses and an access point that performs wireless communication with the sensor apparatuses, in which the access point emits a plurality of beams to an arbitrary point, the sensor apparatus converts the beacon information acquired from the detected beams into compressed beacon information based on a beacon information correspondence table and transmits the compressed beacon information to the access point, and the access point restores the beacon information from the compressed beacon information received from the sensor apparatus based on the beacon information correspondence table.

### TECHNICAL FIELD

The present invention relates to reduction of beacon information transmitted by IoT devices in a network.

### BACKGROUND ART

IoT devices such as sensors have become wide spread and been applied in various industries, but in using sensors for various applications, the importance of data reliability particularly in sensors has increased. The arrangement place (measurement place) of a sensor is important data that maintains the reliability of the sensor.

For example, in a case where an installation error due to the sensor installer occurs or in a case where the sensor is moved to another place by a malicious person, the user of the sensor data may use the sensor data without noticing that the sensor data is erroneous data. Therefore, it is necessary to detect the movement or installation error of the sensor itself, and a technique for visualizing the position of the sensor is required.

There is a technique of estimating a position of a sensor by a Bluetooth low energy (BLE) beacon (for example, see Patent Literature 1 and Patent Literature 2). In this technique, as illustrated in FIG. 1, a BLE beacon (electronic tag transmitter) is placed in a space where a terminal to be measured and a sensor are placed, and positions of the terminal to be measured and the sensor are estimated from reception strength of the terminal to be measured (portable information terminal or the like) and the sensor with respect to radio waves transmitted by the BLE beacon, for example, a received signal strength indicator (RSSI).

### CITATION LIST

### Patent Literature

Patent Literature 1: Japanese Patent No. 5650870
Patent Literature 2: Japanese Patent No. 5723052

### Non Patent Literature

Non Patent Literature 1: https://www.netone-pa.co.jp/solution/wl/mist_outline.php, retrieved on Dec. 16, 2020

### SUMMARY OF INVENTION

### Technical Problem

However, in the method using the BLE beacon, since it is necessary to install a plurality of BLE beacons in the space, a management operation of the BLE beacons occurs. In addition, the BLE beacon moving or becoming lost makes it difficult to perform accurate positioning.

As a technique for solving these problems, Mist Systems (hereinafter, abbreviated as “Mist”) is known (see, for example, Non Patent Literature 1). In Mist, as illustrated in FIG. 2, a plurality of beams are emitted from a Mist access point (Mist AP), and positions of the measurement target terminal and the sensor are estimated from reception strength of the beams in the measurement target terminal and the sensor. By using Mist, it is possible to obtain the same effect as that of installing a BLE beacon at a radiation destination of the beam. Therefore, by emitting a beam by Mist, it can be considered that a virtual beacon is arranged at a radiation destination.

In addition, in Mist, the radiation direction of the beam is variable, and the radiation range can be easily moved by changing the radiation direction of the beam. This corresponds to moving the installation location of the BLE beacon. That is, Mist is easier than moving a physically installed BLE beacon because Mist only changes the radiation direction of the beam when it is desired to change the position estimation target space. Further, in Mist, since a virtual beacon can be generated by the beam of the BLE access point, it is not necessary to physically deploy the beacon. Therefore, in the Mist, operation management such as battery replacement of the beacon itself is not necessary, and the beacon is not lost or stolen or moved without permission.

However, in the related art, information (beam information and strength information of each beam) of a plurality of beams received by a sensor is transmitted to a host cloud or a server to estimate a position. Therefore, as the number of beams increases, traffic to be transmitted also increases. Therefore, there is a problem that traffic and power consumption are great in a limited transmission capacity such as that of an IoT sensor.

In order to solve the above problems, an object of an IoT communication system and an IoT communication method according to the present disclosure is to reduce traffic necessary for transmission of beacon information from a sensor apparatus to an access point without affecting position estimation processing in a high-order cloud or server, and to reduce power consumption.

In order to solve the above problems, an object of an access point and a program according to the present disclosure is to receive beacon information with less traffic and low power consumption without affecting position estimation processing in a high-order cloud or server.

In order to solve the above problem, an object of a sensor apparatus and a program according to the present disclosure is to transmit beacon information with less traffic and low power consumption.

### Solution to Problem

In order to achieve the above object, in the present disclosure, a sensor apparatus compresses beacon information acquired from a plurality of beams based on a beacon information correspondence table and transmits the beacon information to an access point, and the access point restores the compressed beacon information based on the beacon information correspondence table.

Specifically, an Internet of Things (IoT) communication system according to the present disclosure is the IoT communication system including one or a plurality of sensor apparatuses and an access point that performs wireless communication with the sensor apparatuses, in which the access point emits a plurality of beams each having an identification ID to an arbitrary point, the sensor apparatus detects the beams, converts the beacon information acquired from the detected beams into the compressed beacon information based on a beacon information correspondence table in which the identification ID and an identifier corresponding to the identification ID are described, and transmits the compressed beacon information to the access point, and the access point receives the compressed beacon information from the sensor apparatus, and restores the beacon information from the compressed beacon information based on the beacon information correspondence table.

For example, the sensor apparatus transmits the compressed beacon information to the access point together with sensing data acquired by the sensor apparatus.

In addition, the sensor apparatus transmits the compressed beacon information to the access point separately from sensing data acquired by the sensor apparatus.

Specifically, an Internet of Things (IoT) communication method according to the present disclosure is the IoT communication method in which one or a plurality of sensor apparatuses and an access point perform wireless communication, the IoT communication method including emitting a plurality of beams each having an identification ID, from the access point to an arbitrary point, detecting the beams by the sensor apparatus, converting the beacon information acquired from the detected beams into the compressed beacon information based on a beacon information correspondence table in which the identification ID and an identifier corresponding to the identification ID are described, transmitting the compressed beacon information from the sensor apparatus to the access point, and restoring, at the access point, the beacon information from the received compressed beacon information based on the beacon information correspondence table.

In the IoT communication system and the IoT communication method according to the present disclosure, the sensor apparatus compresses the beacon information acquired from the plurality of beams based on the beacon information correspondence table and transmits the beacon information to the access point, and the access point restores the compressed beacon information based on the beacon information correspondence table, so that it is possible to reduce the traffic necessary for transmission of the beacon information from the sensor apparatus to the access point without affecting the position estimation processing in the upper cloud or the server, and reduce the power consumption.

Specifically, an access point according to the present disclosure is the access point that performs wireless communication with a sensor apparatus, the access point including a beacon-AP unit that emits a plurality of beams each having an identification ID to an arbitrary point and a sensor-AP unit that receives compressed beacon information of the beam from the sensor apparatus that has detected the beams, and restores beacon information from the compressed beacon information based on a beacon information correspondence table in which the identification ID and an identifier corresponding to the identification ID are described.

Specifically, a program according to the present disclosure is the program for causing a computer to function as the access point.

The access point according to the present disclosure can receive the beacon information with less traffic and low power consumption without affecting the position estimation processing in the high-order cloud or server by restoring the beacon information received in a compressed state based on the beacon information correspondence table.

Specifically, a sensor apparatus according to the present disclosure is the sensor apparatus that performs wireless communication with an access point, the sensor apparatus including a beacon transmission/reception processing unit that detects a plurality of beams emitted from the access point and each having an identification ID, a beacon data storage processing unit that converts the beacon information acquired from the detected beams into the compressed beacon information based on a beacon information correspondence table in which the identification ID and an identifier corresponding to the identification ID are described, and a wireless transmission/reception processing unit that transmits the compressed beacon information to the access point.

Specifically, the program according to the present disclosure causes a computer to function as the access point according to claim 4.

The sensor apparatus according to the present disclosure can transmit beacon information with less traffic and low power consumption by compressing beacon information acquired from a plurality of beams based on the beacon information correspondence table and transmitting the beacon information to an access point.

### Advantageous Effects of Invention

According to the present disclosure, it is possible to provide an IoT communication system, an access point, a sensor apparatus, an IoT communication method, and a program capable of reducing traffic necessary for transmission of beacon information from a sensor apparatus to an access point and reducing power consumption without affecting position estimation processing in a high-order cloud or server.

### BRIEF DESCRIPTION OF DRAWINGS

FIG. 1 is a diagram illustrating a conventional technique of the present invention.

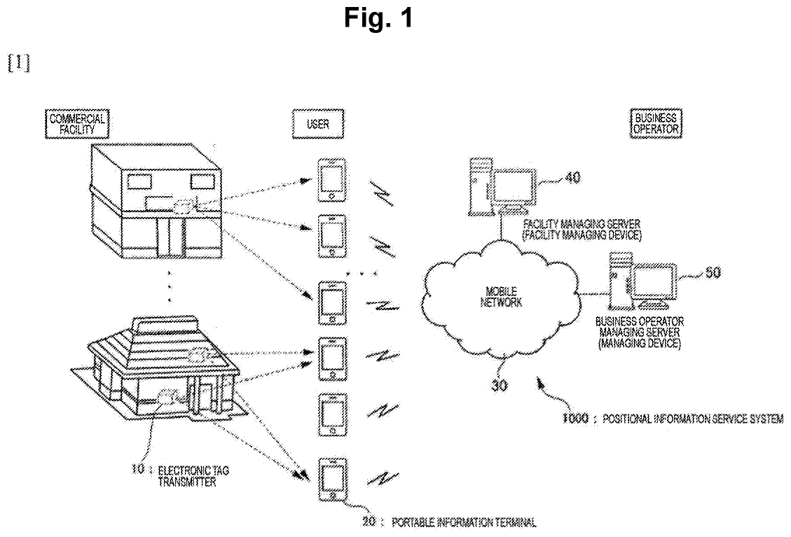

FIG. 2 is a diagram illustrating a conventional technique of the present invention.

FIG. 3 illustrates a schematic configuration of an IoT communication system according to the present invention.

FIG. 4 illustrates an example of a beacon information correspondence table according to the present invention.

FIG. 5 illustrates an example of beacon information according to the present invention.

FIG. 6 illustrates an example of compressed beacon information according to the present invention.

FIG. 7 illustrates an example of a schematic configuration of a sensor-AP unit according to the present invention.

FIG. 8 illustrates an example of a schematic configuration of a sensor apparatus according to the present invention.

FIG. 9 illustrates an example of a procedure of an IoT communication method according to the present invention.

FIG. 10 illustrates an example of a schematic configuration of the sensor apparatus according to the present invention.

FIG. 11 illustrates an example of a schematic configuration of the sensor-AP unit according to the present invention.

FIG. 12 is a diagram illustrating a program according to the present invention.

### DESCRIPTION OF EMBODIMENTS

Hereinafter, an embodiment of the present disclosure will be described in detail with reference to the drawings. Note that the present invention is not limited to the embodiments described below. These embodiments are merely examples, and the present disclosure can be carried out in a form with various modifications and improvements based on the knowledge of those skilled in the art. Note that components having the same reference numerals in the present specification and the drawings denote the same constituents.

### First Embodiment

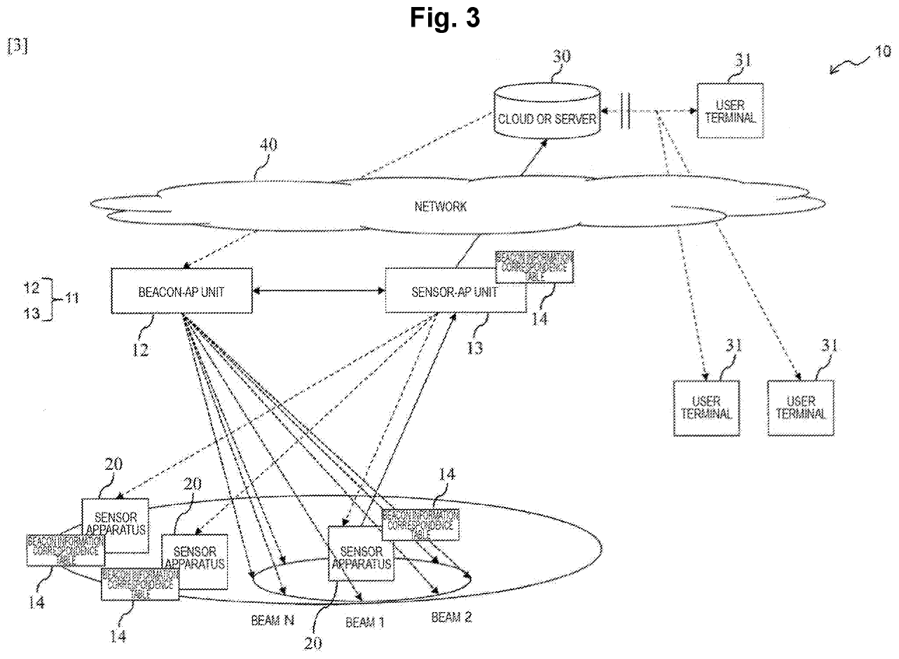

FIG. 3 illustrates an example of a schematic configuration of the IoT communication system according to the present embodiment.

An Internet of Things (IoT) communication system 10 is
an IoT communication system including one or a plurality of sensor apparatuses 20 and an access point 11 that performs wireless communication with the sensor apparatuses 20, in which
the access point 11 emits a plurality of beams each having an identification ID to an arbitrary point,
the sensor apparatus 20 detects the beam, converts the beacon information acquired from the detected beams into the compressed beacon information based on a beacon information correspondence table 14 in which the identification ID and an identifier corresponding to the identification ID are described, and transmits the compressed beacon information to the access point 11, and
the access point 11 receives the compressed beacon information from the sensor apparatus 20, and restores the beacon information from the compressed beacon information based on the beacon information correspondence table 14. Note that, the IoT communication system 10 may include a plurality of access points 11.

The access point 11 is
the access point 11 that performs wireless communication with a sensor apparatus 20, the access point including
a beacon-AP unit 12 that emits a plurality of beams each having an identification ID to an arbitrary point, and
a sensor-AP unit 13 that receives compressed beacon information of the beam from the sensor apparatus 20 that has detected the beams, and restores beacon information from the compressed beacon information based on the beacon information correspondence table 14 in which the identification ID and an identifier corresponding to the identification ID are described.

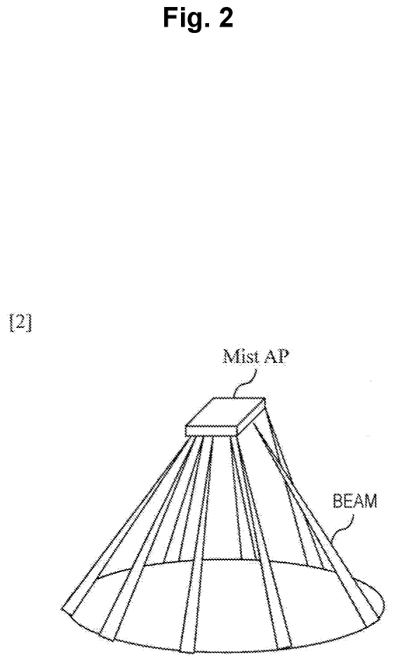

The beacon-AP unit 12 and the sensor-AP unit 13 may be connected to a cloud or server 30 via a network 40. Furthermore, the cloud or server 30 may be connected to a user terminal 31. The beacon-AP unit 12 and the sensor-AP unit 13 are, for example, a Mist AP described in FIG. 2.

Note that, the beacon information may be the identification ID of the beams and the strength of the beams detected by the sensor apparatus 20. Further, time information may be included. In addition, the compressed beacon information is obtained by compressing the beacon information to reduce the amount of data. The conversion between the beacon information and the compressed beacon information is performed based on the beacon information correspondence table 14.

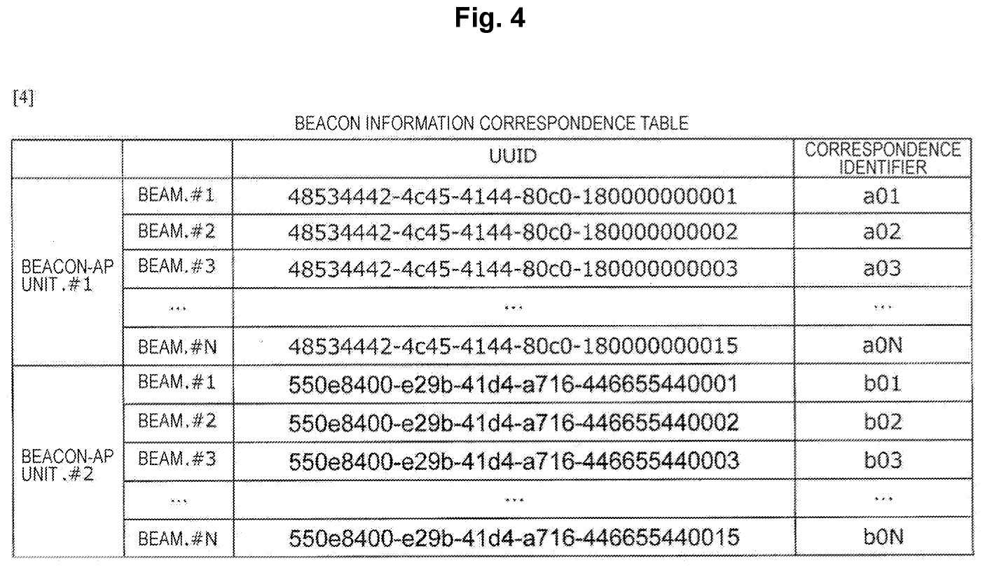

An example of the beacon information correspondence table 14 is illustrated in FIG. 4. In the present embodiment, a universally unique identifier (UUID) is exemplified as the identification ID of the beam. The UUID identifies both the beacon-AP unit 12 and the beam. For example, as illustrated in FIG. 4, a beam whose UUID is “48534442-4c45-4144-80c0-180000000001” is identified as the beam. #1 emitted by the beacon-AP unit. #1.

In addition, in the identifier illustrated in FIG. 4, each UUID is displayed in a simple format so that the data amount of the beacon information is reduced, and both the beacon-AP unit 12 and the beam can be identified similarly to the UUID.

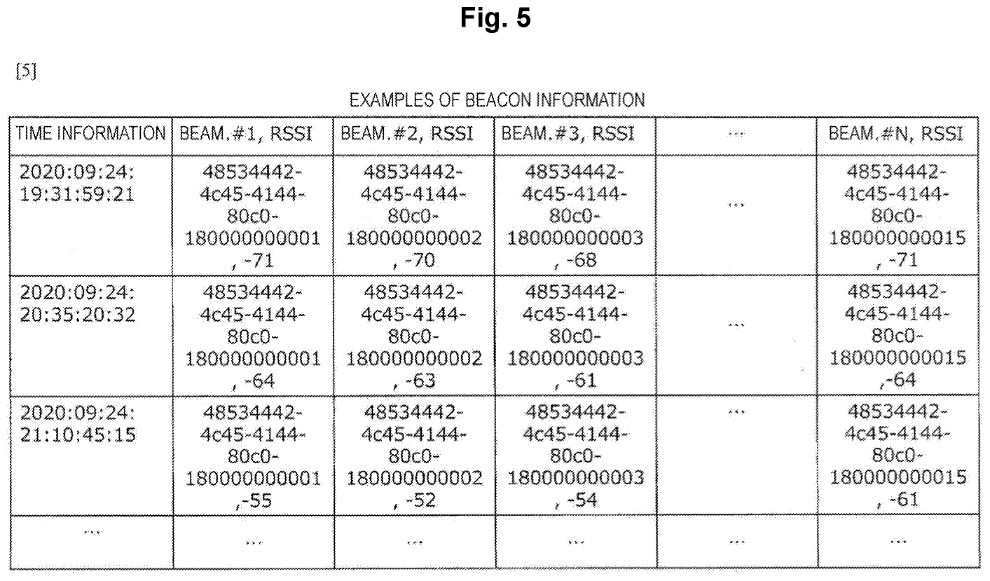

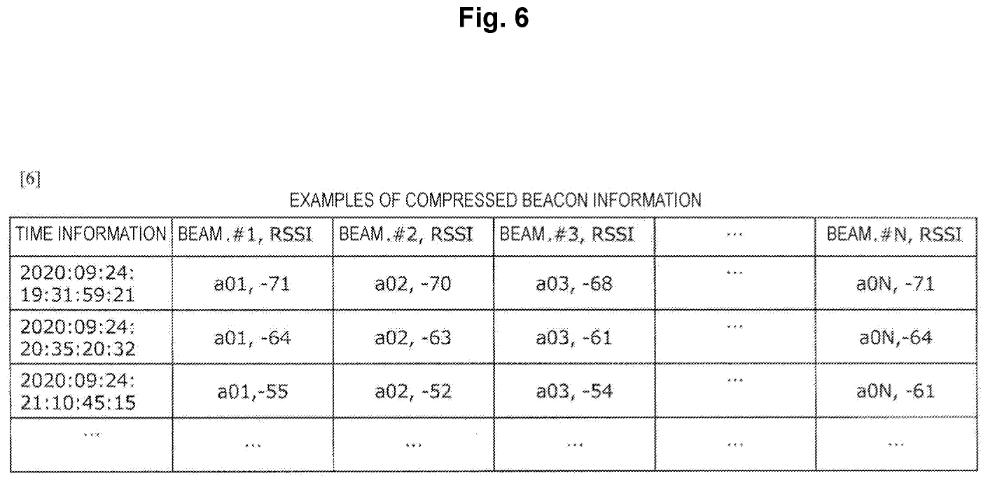

In the present embodiment, a set of the UUID, the strength of the beam (received signal strength indicator (RSSI)), and the time information is set as beacon information, and an example of the beacon information is illustrated in FIG. 5. In addition, a set of the identifier, the beam strength, and the time information is set as compressed beacon information, and an example of the compressed beacon information is illustrated in FIG. 6. The time information in FIGS. 5 and 6 is time information when the sensor apparatus 20 described later detects a beam. As illustrated in FIGS. 5 and 6, the beacon information and the compressed beacon information may include information at a plurality of times, and the same row may be information at the same time. The column “Beam. #1, RSSI” in FIG. 5 represents the UUID of the beam. #1 and the strength of the beam. The column “Beam. #1, RSSI” in FIG. 6 represents the identifier of the beam. #1 and the strength of the beam. A difference between FIGS. 5 and 6 is that beam identification is performed by the UUID in FIG. 5 and by the identifier in FIG. 6.

The beacon-AP unit 12 emits a plurality of beams each having the UUID to an arbitrary point. The emission of the beam by the beacon-AP unit 12 may be controlled by a control signal from the cloud or server 30. Furthermore, for the beam, a radio wave similar to the BLE beacon may be used, or an optical wave, a sound wave, or the like may be used. In the present embodiment, it is assumed that N beams are output from one beacon-AP unit 12.

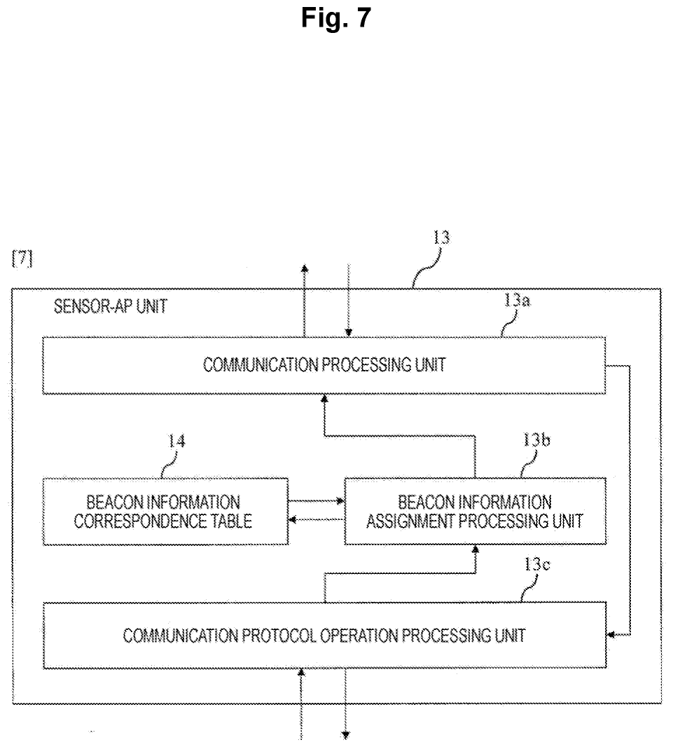

FIG. 7 illustrates an example of a schematic configuration of the sensor-AP unit 13. The sensor-AP unit 13 includes a communication protocol operation processing unit 13c, the beacon information correspondence table 14, a beacon information assignment processing unit 13b, and a communication processing unit 13a.

The communication protocol operation processing unit 13c transmits the beacon information correspondence table 14 to the sensor apparatus 20. The beacon information correspondence table 14 may be transmitted to each sensor apparatus 20 by broadcasting using an extension area of a communication protocol. For example, broadcasting may be performed using a Wi-Fi beacon, a Probe response, a Link Layer Discovery Protocol (LLDP), or the like. As a result, the beacon information correspondence table 14 can be easily installed in the sensor apparatus 20 without changing the sensor apparatus 20.

The communication protocol operation processing unit 13c acquires the compressed beacon information and the sensing data from the sensor apparatus 20. Further, the communication protocol operation processing unit 13c may be able to extract the sensing data and the compressed beacon information when the sensor apparatus 20 transmits the compressed beacon information together with its own acquired sensing data.

The beacon information assignment processing unit 13b restores the beacon information from the compressed beacon information based on the beacon information correspondence table 14. Specifically, the identifier in the compressed beacon information in FIG. 6 is restored to the UUID using the beacon information correspondence table 14 in FIG. 4 to be the beacon information in FIG. 5. Thereafter, the restored beacon information and the sensing data acquired by the sensor apparatus 20 are written in the payload portion of the data transmitted by the communication processing unit 13a.

The communication processing unit 13a transmits the sensing data and the beacon information written in the payload portion to the cloud or server 30 via wireless communication or wired communication.

The access point 11 according to the present embodiment can receive the beacon information with less traffic and low power consumption without affecting the position estimation processing in the high-order cloud or server by restoring the beacon information received in a compressed state based on the beacon information correspondence table.

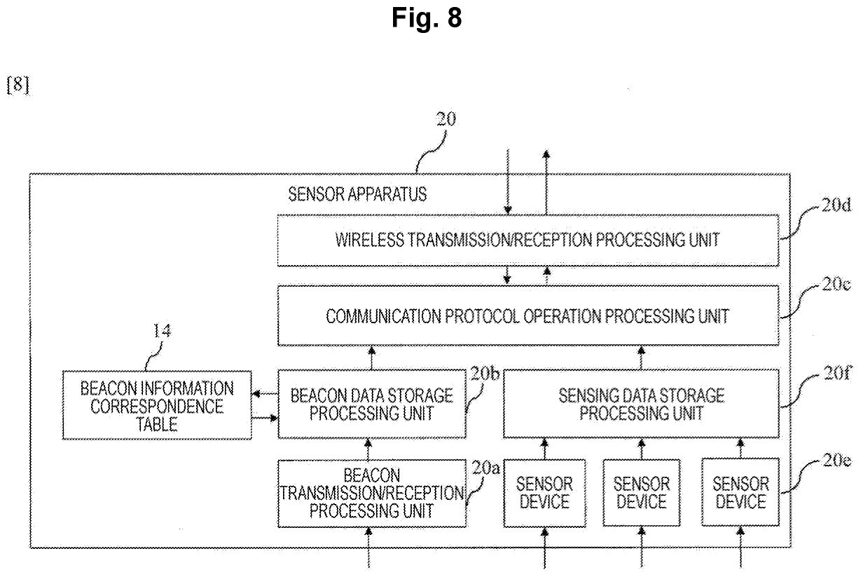

FIG. 8 illustrates an example of a schematic configuration of the sensor apparatus 20.

The sensor apparatus 20 is
the sensor apparatus 20 that performs wireless communication with the access point 11, the sensor apparatus including
a beacon transmission/reception processing unit 20a that detects a plurality of beams emitted from the access point 11 and each having an identification ID (UUID),
a beacon data storage processing unit 20b that converts beacon information acquired from a detected beam into compressed beacon information based on a beacon information correspondence table 14 in which a UUID and an identifier corresponding to the UUID are described, and
a wireless transmission/reception processing unit 20d that transmits compressed beacon information to the access point 11.

Furthermore, the sensor apparatus 20 receives the beacon information correspondence table 14 of FIG. 4 described above from the sensor-AP unit 13 and holds the same therein. The sensor apparatus 20 includes a communication protocol operation processing unit 20c that performs a protocol operation according to a wireless system owned by the sensor apparatus.

The sensor apparatus 20 may include one or a plurality of sensor devices 20e. In addition, a sensing data storage processing unit 20f that processes sensing data acquired by the sensor device 20e and stores the processed sensing data in a payload portion of data transmitted by the wireless transmission/reception processing unit 20d may be provided.

The beacon transmission/reception processing unit 20a acquires the above-described beacon information by detecting the UUID of the beam from the signal pattern of the beam transmitted from the beacon-AP unit 12 and detecting the strength of the beam. The beacon transmission/reception processing unit 20a transmits the acquired beacon information of FIG. 5 to the beacon data storage processing unit 20b.

The beacon data storage processing unit 20b converts the acquired beacon information into compressed beacon information based on the beacon information correspondence table 14. Similarly to the sensing data acquired by the sensor device 20e, the beacon data storage processing unit 20b may store the compressed beacon information in the payload portion of the data transmitted by the wireless transmission/reception processing unit 20d, and transmit the compressed beacon to the access point 11 together with the sensing data. In addition, the data may be stored after fragmenting or the like so as to conform to the mode or restriction of the communication protocol to be used.

The wireless transmission/reception processing unit 20d performs radio frequency (RF) wireless processing with the communication protocol operation processing unit 13c of the sensor-AP unit 13. As a wireless method, Wi-Fi, Low Power Wide Area (LPWA), and other methods for sensors are assumed.

The sensor apparatus according to the present embodiment transmits beacon information with less traffic and low power consumption by compressing beacon information acquired from a plurality of beams based on the beacon information correspondence table and transmitting the beacon information to an access point.

The cloud or server 30 illustrated in FIG. 3 notifies the user terminal 31 of the sensing data transmitted from the sensor-AP unit 13. Accordingly, the cloud or server 30 may estimate the position of the sensor apparatus 20 from the beacon information transmitted from the sensor-AP unit 13 and notify the user terminal 31 of the estimated position of the sensor apparatus 20. Furthermore, in a case where the estimated position of the sensor apparatus 20 is moved from the position of the sensor apparatus 20 installed in advance, the previously estimated position of the sensor apparatus 20, or the like, the movement may be detected and notified to the user terminal 31. In addition, in a case where the beacon information is not transmitted from the sensor-AP unit 13, it may be considered that the sensor apparatus 20 is in a state of failure, loss, or the like. The cloud or server 30 may transmit information related to beam control to the beacon-AP unit 12.

The user terminal 31 acquires sensing data of the sensor apparatus 20 from the cloud or server 30. In addition, notification of the position or movement of the position of the sensor apparatus 20 may be received.

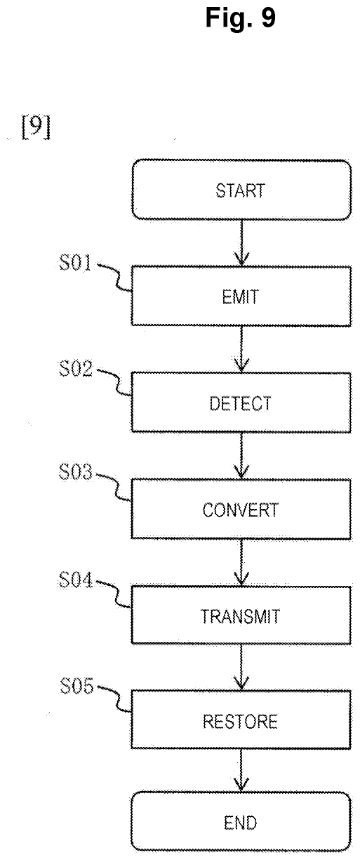

FIG. 9 illustrates an example of a procedure of an IoT communication method.

The Internet of Things (IoT) communication method is
an IoT communication method in which one or a plurality of sensor apparatuses 20 and the access point 11 perform wireless communication, the method including
emitting a plurality of beams each having an identification ID from the access point 11 to an arbitrary point (step S01),
detecting a beam by the sensor apparatus 20 (step S02),
converting the beacon information acquired from a detected beam into the compressed beacon information based on a beacon information correspondence table 14 in which an identification ID and an identifier corresponding to the identification ID are described (step S03),
transmitting compressed beacon information from the sensor apparatus 20 to the access point 11 (step S04), and
returning the received compressed beacon information to the beacon information in the access point 11 based on the beacon information correspondence table 14 (step S05).

### (Step S01)

As described above, the access point 11 emits a plurality of beams having the UUID to an arbitrary point by the beacon-AP unit 12.

### (Step S02)

As described above, the sensor apparatus 20 detects the emitted beam by the beacon transmission/reception processing unit 20a and acquires the beacon information.

### (Step S03)

As described above, in the sensor apparatus 20, the beacon data storage processing unit 20b converts the acquired beacon information into the compressed beacon information in FIG. 6 based on the beacon information correspondence table 14 in FIG. 4, and stores the compressed beacon information in the payload portion of the data transmitted by the wireless transmission/reception processing unit 20d.

### (Step S04)

As described above, the sensor apparatus 20 transmits the compressed beacon information to the communication protocol operation processing unit 13c of the sensor-AP unit 13 by the wireless transmission/reception processing unit 20d.

### (Step S05)

In the access point 11, as described above, in the sensor-AP unit 13, the communication protocol operation processing unit 13c acquires the compressed beacon information from the sensor apparatus 20, and the beacon information assignment processing unit 13b restores the beacon information from the compressed beacon information based on the beacon information correspondence table 14.

The beacon information acquired by the IoT communication method according to the present embodiment is used for position estimation of the sensor apparatus 20, similarly to the IoT communication system 10 described above.

As described above, in the IoT communication system and the IoT communication method according to the present embodiment, the sensor apparatus compresses the beacon information acquired from the plurality of beams based on the beacon information correspondence table and transmits the beacon information to the access point, and the access point restores the compressed beacon information based on the beacon information correspondence table, so that it is possible to reduce the traffic necessary for transmission of the beacon information from the sensor apparatus to the access point without affecting the position estimation processing in the upper cloud or the server, and reduce the power consumption.

### Second Embodiment

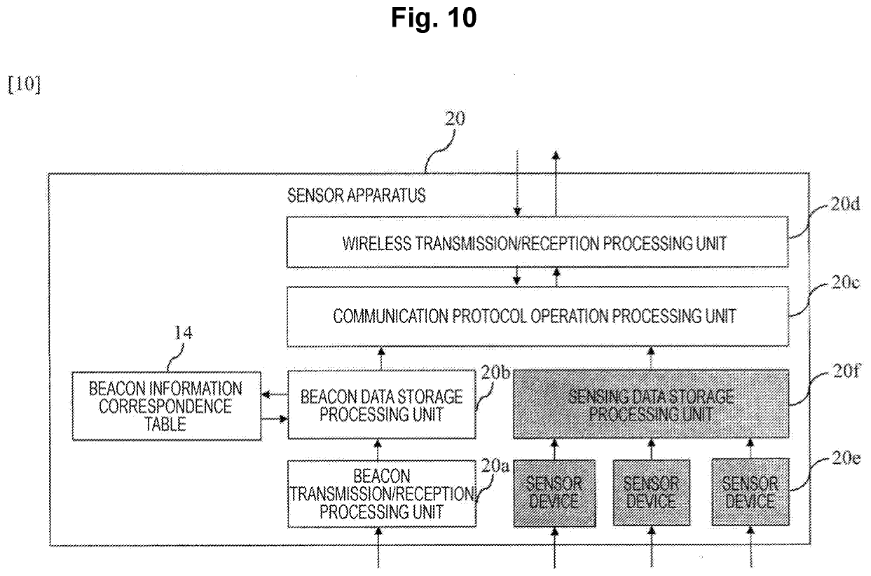

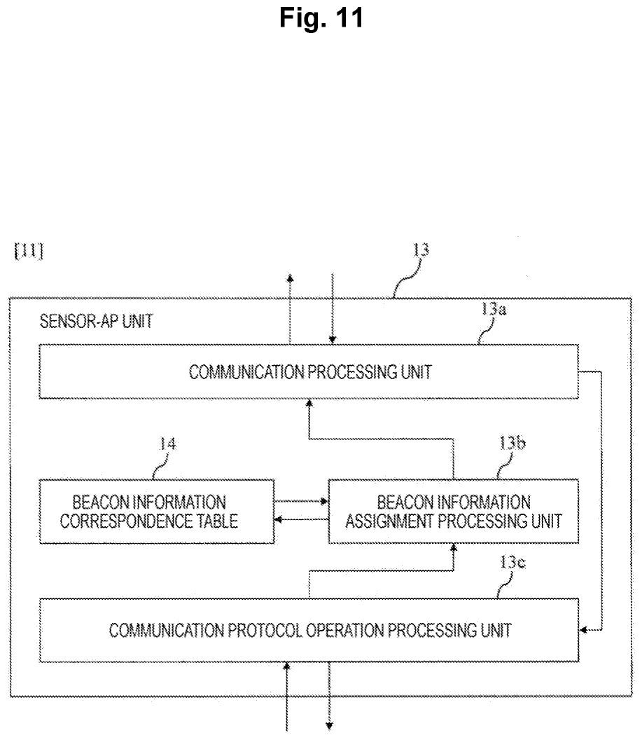

Hereinafter, configurations of the access point 11 and the sensor apparatus 20 according to the present embodiment will be specifically described with reference to FIGS. 10 and 11. The sensor apparatus 20 according to the present embodiment is different in a method of transmitting compressed beacon information to the access point 11. Hereinafter, differences from Embodiment 1 will be described, and contents other than the contents described below are similar to those of the first embodiment.

The sensor apparatus 20 transmits compressed beacon information to the access point 11 separately from the sensing data acquired by itself.

Specifically, in step S03 of the first embodiment, the beacon data storage processing unit 20b may store the compressed beacon information in the frame of the communication negotiation of the wireless communication protocol. For example, when the 802.11 wireless communication protocol is taken as an example, there is an extended area of a Probe Request frame. Similarly to the first embodiment, the data may be stored after fragmenting or the like so as to conform to the mode/restriction of the communication protocol to be used.

In step S05 of the first embodiment, the communication protocol operation processing unit 13c of the access point 11 extracts the compressed beacon information from the frame of the communication negotiation of the wireless protocol. The sensing data is acquired from the payload portion similarly to the first embodiment.

As described above, the sensor apparatus 20 can transmit the beacon information before the communication with the access point 11 is established by transmitting the compressed beacon information to the access point 11 separately from the sensing data acquired by itself. As a result, the beacon information can be reflected in the IP address setting or the like.

### Third Embodiment

A program according to the present embodiment is a program for causing a computer to function as the access point 11. The access point 11 can also be formed with a computer and a program, and the program can be recorded on a recording medium or be provided through a network. The computer in which the program is installed realizes the access point 11 described in the first embodiment or the second embodiment.

### Fourth Embodiment

A program according to the present embodiment is a program for causing a computer to function as the sensor apparatus 20. The sensor apparatus 20 can also be realized by a computer and a program, and the program can be recorded in a recording medium or provided through a network. The computer in which the program is installed realizes the sensor apparatus 20 described in the first embodiment or the second embodiment.

### Fifth Embodiment

The access point 11 and the sensor apparatus 20 can also be formed with a computer and a program, and the program can be recorded on a recording medium or be provided through a network.

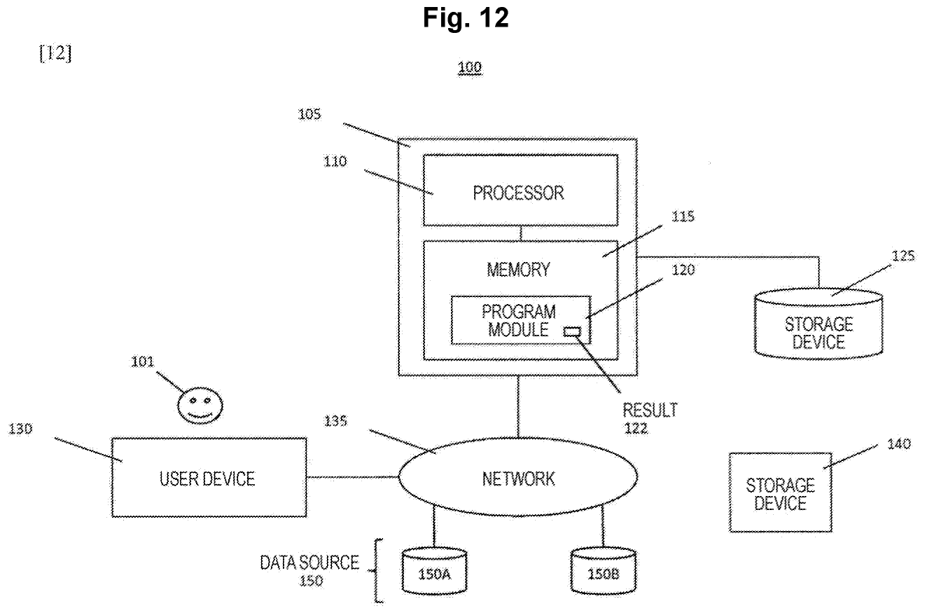

FIG. 12 illustrates a block diagram of a system 100. The system 100 includes a computer 105 connected to a network 135.

The network 135 is a data communication network. The network 135 may be a private network or a public network, and may include any or all of (a) a personal area network, for example, covering a room, (b) a local area network, for example, covering a building, (c) a campus area network, for example, covering a campus, (d) a metropolitan area network, for example, covering a city, (e) a wide area network, for example, covering an area connected across boundaries of cities, rural areas, or the countries, or (f) the Internet. Communication is performed by an electronic signal and an optical signal via the network 135.

The computer 105 includes a processor 110 and a memory 115 connected to the processor 110. The computer 105 is represented herein as a standalone device, but is not limited in this way, and rather may be connected to other devices (not shown) in a distributed processing system.

The processor 110 is an electronic device including logic circuitry that responds to and executes instructions.

The memory 115 is a tangible computer readable storage medium in which a computer program is encoded. In this regard, the memory 115 stores data and instructions, i.e., program codes, that are readable and executable by the processor 110 to control the operation of the processor 110. The memory 115 may be implemented by a random access memory (RAM), a hard drive, a read-only memory (ROM), or a combination thereof. One of the components of the memory 115 is a program module 120.

The program module 120 includes instructions for controlling the processor 110 to perform processes described herein. In the present specification, operations are described as being performed by the computer 105 or a method or a process or a sub-process thereof. The operations are actually executed by the processor 110.

The term “module” is used herein to refer to a functional operation that may be embodied either as a stand-alone component or as an integrated configuration of a plurality of sub-components. Therefore, the program module 120 can be implemented as a single module or as a plurality of modules that operates in cooperation with each other. Furthermore, although the program module 120 is described herein as being installed in the memory 115 and thus implemented in software, the program module can be implemented in any of hardware (for example, an electronic circuit), firmware, software, or a combination thereof.

Although shown as already loaded into the memory 115, the program module 120 may be configured to be located on a storage device 140 so as to be subsequently loaded into the memory 115. The storage device 140 is a tangible computer readable storage medium that stores the program module 120. Examples of the storage device 140 include a compact disk, a magnetic tape, a read-only memory, an optical storage media, a hard drive or a memory unit including a plurality of parallel hard drives, and a universal serial bus (USB) flash drive. Alternatively, the storage device 140 may be a random access memory or another type of electronic storage device located in a remote storage system (not shown) and connected to the computer 105 via the network 135.

The system 100 described herein further includes a data source 150A and a data source 150B collectively referred to as a data source 150, and communicatively connected to the network 135. In practice, the data source 150 may include any number of data sources, i.e., one or more data sources. The data source 150 includes unstructured data and may include social media.

The system 100 further includes a user device 130 operated by a user 101 and connected to the computer 105 via the network 135. The user device 130 includes an input device, such as a keyboard or voice recognition subsystem, for enabling the user 101 to communicate information and command selections to the processor 110. The user device 130 further includes an output device such as a display device, a printer, or a speech synthesizer. A cursor control unit, such as a mouse, a trackball, or a touch-sensitive screen, allows the user 101 to manipulate a cursor on the display device to communicate further information and command selections to the processor 110.

The processor 110 outputs a result 122 of execution of the program module 120 to the user device 130. Alternatively, the processor 110 may provide the output to a storage device 125 such as a database or a memory, or to a remote device not shown, via the network 135.

For example, a program that performs steps S01 and S05 in the flowchart of FIG. 9 may be used as the program module 120. The system 100 may be operated as the access point 11 described in FIGS. 3 and 7 or 11. In addition, a program for performing steps S02 to S04 in the flowchart of FIG. 9 may be used as the program module 120. The system 100 can be operated as the sensor apparatus 20 described in FIGS. 8 and 10.

The term “comprise . . . ” or “comprising . . . ” specify that the feature, integer, step, or component mentioned is present, but should be construed as not excluding that one or more other features, integers, steps, or components, or groups thereof are present. The terms “a” and “an” are indefinite articles for an object and therefore do not exclude embodiments having a plurality of objects.

### OTHER EMBODIMENTS

Note that the present invention is not limited to the above embodiments, and various modifications can be made without departing from the gist of the present invention. In short, the present invention is not limited to the high-order embodiment as it is, and in the implementation stage, the components can be modified and embodied without departing from the gist thereof. For example, although one access point 11 has been described in the above embodiment, the position of the sensor apparatus 20 can be estimated even in a case where the IoT communication system 10 includes two or more access points 11.

Additionally, various inventions can be made by appropriately combining a plurality of components disclosed in the above embodiments. For example, some components may be deleted from all the components shown in the embodiments. Further, constituent elements in different embodiments may be appropriately combined.

### INDUSTRIAL APPLICABILITY

The IoT communication system, the access point, the sensor apparatus, the IoT communication method, and the program according to the present disclosure can be applied to the information communication industry.

### REFERENCE SIGNS LIST

10 IoT communication system
11 Access point
12 Beacon-AP unit
13 Sensor-AP unit
13a Communication processing unit
13b Beacon information assignment processing unit
13c Communication protocol operation processing unit
14 Beacon information correspondence table
20 Sensor apparatus
20a Beacon transmission/reception processing unit
20b Beacon data storage processing unit
20c Communication protocol operation processing unit
20d Wireless transmission/reception processing unit
20e Sensor device
20f Sensing data storage processing unit
30 Cloud or server
31 User terminal
40 Network
100 System
101 User
105 Computer
110 Processor
115 Memory
120 Program module
122 Result
125 Storage device
130 User device
135 Network
140 Storage device
150 Data source

1. An Internet of Things (IoT) communication system comprising: one or a plurality of sensor apparatuses; and an access point that performs wireless communication with the sensor apparatuses, wherein
the access point emits a plurality of beams each having an identification ID to an arbitrary point,
the sensor apparatus detects the beams, converts beacon information acquired from the detected beams into compressed beacon information based on a beacon information correspondence table in which the identification ID and an identifier corresponding to the identification ID are described, and transmits the compressed beacon information to the access point, and
the access point receives the compressed beacon information from the sensor apparatus, and restores the beacon information from the compressed beacon information based on the beacon information correspondence table.

2. The IoT communication system according to claim 1, wherein
the sensor apparatus transmits the compressed beacon information to the access point together with sensing data acquired by the sensor apparatus.

3. The IoT communication system according to claim 1, wherein
the sensor apparatus transmits the compressed beacon information to the access point separately from sensing data acquired by the sensor apparatus.

4. (canceled)

5. A sensor apparatus that performs wireless communication with an access point, the sensor apparatus comprising:
a beacon transmission/reception processing unit that detects a plurality of beams emitted from the access point and each having an identification ID;
a beacon data storage processing unit that converts beacon information acquired from the detected beams into compressed beacon information based on a beacon information correspondence table in which the identification ID and an identifier corresponding to the identification ID are described; and
a wireless transmission/reception processing unit that transmits the compressed beacon information to the access point.

6. An Internet of Things (IoT) communication method in which one or a plurality of sensor apparatuses and an access point perform wireless communication, the IoT communication method comprising:
emitting a plurality of beams each having an identification ID, from the access point to an arbitrary point;
detecting the beams by the sensor apparatus;
converting beacon information acquired from the detected beams into compressed beacon information based on a beacon information correspondence table in which the identification ID and an identifier corresponding to the identification ID are described;
transmitting the compressed beacon information from the sensor apparatus to the access point; and
restoring, at the access point, the beacon information from the received compressed beacon information based on the beacon information correspondence table.

7. (canceled)

8. A non-transitory computer-readable medium having computer-executable instructions that, upon execution of the instructions by a processor of a computer, cause the computer to function as the sensor apparatus according to claim 5.
